(19) United States
(12) Patent Application Publication
(10) Pub. No.: US 2025/0211149 A1
(43) Pub. Date: Jun. 26, 2025

(54) CONTROL DEVICE FOR ALTERNATING-CURRENT ELECTRIC MOTOR AND ELECTRIC VEHICLE EQUIPPED WITH THE SAME, AND ELECTRIC AIRCRAFT

(71) Applicant: Hitachi, Ltd., Tokyo (JP)

(72) Inventors: Wataru HATSUSE, Tokyo (JP); Takafumi HARA, Tokyo (JP); Toshiyuki AJIMA, Tokyo (JP)

(21) Appl. No.: 18/848,551

(22) PCT Filed: May 16, 2023
(86) PCT No.: PCT/JP2023/018270

§ 371 Date: Sep. 19, 2024

(30) Foreign Application Priority Data
Aug. 4, 2022 (JP) 2022-124709

(51) Int. Cl. H02P 21/18; H02P 27/06

(52) U.S. Cl. CPC H02P 21/18; H02P 27/06

(57) ABSTRACT

The control device controls an alternating-current electric motor via an inverter based on angle information of a position sensor. The position sensor is set such that the ratio between the number of polar pairs of the alternating-current electric motor and the axial double angle X of the position sensor is an integer multiple. The control device includes an electrical angle phase calculation unit that multiplies angle information detected by the position sensor by an integer multiple and converts the multiplied angle information into electrical angle phase information, an electrical angle rotation number calculation unit that calculates an electrical angle rotation number based on the electrical angle phase information calculated by the electrical angle phase calculation unit, and a vector control unit that calculates a voltage command value to be output to the inverter based on the electrical angle phase information.

### TECHNICAL FIELD

The present invention relates to a control device for an alternating-current electric motor that drives an alternating-current electric motor, an electric vehicle including the same, and an electric aircraft.

### BACKGROUND ART

In recent years, due to an increasing demand for energy saving, a control device for an alternating-current electric motor for driving an alternating-current electric motor have been applied to a wide range of applications such as home appliances, infrastructures, and industrial equipment. In particular, in an electric vehicle, in order to expand a vehicle interior space and a battery installation space, an in-wheel motor in which an alternating-current electric motor is disposed in a wheel has been studied. In the in-wheel motor, there is a strong demand for miniaturization and high power density, and therefore the motor is designed to have multiple poles.

Furthermore, as one of the methods of the control device for driving the alternating-current electric motor, there is a configuration in which a resolver is used as a means for detecting the rotation position and the rotation speed of the alternating-current electric motor. A resolver is a sensor that is mounted to a rotation shaft, rotates together with the rotation shaft, and converts a mechanical angle of the rotation shaft into an electric signal using electromagnetic induction, and excels in environmental resistance and has been applied to a wide range of applications.

However, the resolver has an upper limit on the number of poles that can be handled in principle using electromagnetic induction. The maximum number of poles of a typical resolver is about ten poles. In addition, it is known that, in the resolver, noise proportional to the rotation number of the alternating-current electric motor is generated in the angle signal due to a mounting error or the like.

As a technique for removing noise proportional to the rotation number of such an alternating-current electric motor, for example, a technique described in PTL 1 has been proposed. In PTL 1, noise included in an angle signal is suppressed by using a filter that attenuates a specific frequency component.

### CITATION LIST

### Patent Literature

PTL 1: JP 6222834 A

### SUMMARY OF INVENTION

### Technical Problem

The number of poles of the multipolar alternating-current electric motor is larger than the maximum number of poles of a typical resolver. For this reason, when the resolver is used for the multipolar alternating-current electric motor, the resolver having the number of poles smaller than the number of poles of the alternating-current electric motor is used. In other words, there is a problem that the phase difference between the electrical angle phase with respect to one rotation of the mechanical angle of the alternating-current electric motor and the angle information of the resolver increases.

In the technique described in PTL 1, although noise caused by the resolver can be suppressed, a problem that the electrical angle phase difference becomes large when the resolver having a smaller number of poles is applied to the multipolar alternating-current electric motor is not considered at all. Therefore, it is difficult to stably perform vector control on the multipolar alternating-current electric motor.

An object of the present invention is to provide an alternating-current electric motor control device capable of stably performing vector control on a multipolar alternating-current electric motor.

### Solution to Problem

In order to achieve the above object, the present invention provides a control device for an alternating-current electric motor that controls an alternating-current electric motor via an inverter based on angle information of a position sensor that detects an angular position of the alternating-current electric motor, wherein the position sensor is set such that a ratio between a number of polar pairs of the alternating-current electric motor and an axial double angle X of the position sensor is an integer multiple, and the control device includes an electrical angle phase calculation unit that multiplies angle information of the alternating-current electric motor detected by the position sensor by the integer multiple and converts the multiplied angle information into electrical angle phase information of the alternating-current electric motor, an electrical angle rotation number calculation unit that calculates an electrical angle rotation number of the alternating-current electric motor based on the electrical angle phase information of the alternating-current electric motor calculated by the electrical angle phase calculation unit, and a vector control unit that calculates a voltage command value to be output to the inverter based on the electrical angle phase information of the alternating-current electric motor calculated by the electrical angle phase calculation unit and the electrical angle rotation number of the alternating-current electric motor calculated by the electrical angle rotation number calculation unit.

### Advantageous Effects of Invention

According to the present invention, it is possible to provide an alternating-current electric motor control device capable of stably performing vector control on a multipolar alternating-current electric motor.

### BRIEF DESCRIPTION OF DRAWINGS

FIG. 1 is a block diagram illustrating an overall configuration diagram of a driving device for an alternating-current electric motor according to a first example of the present invention.

FIG. 2 is a diagram illustrating a relationship between angle information of a position sensor and an electrical angle of the alternating-current electric motor.

FIG. 3 is a diagram illustrating a relationship between angle information of the position sensor and an electrical angle of the alternating-current electric motor according to a comparative example.

FIG. 4A is a diagram illustrating a relationship between angle information of the position sensor including a noise component and an electrical angle of the alternating-current electric motor.

FIG. 4B is a diagram comparing the noise component for one rotation of the position sensor phase information with the noise component after the calculation by the electrical angle phase calculation unit 22.

FIG. 5 is a block diagram illustrating an overall configuration diagram of a driving device for an alternating-current electric motor according to a second example of the present invention.

FIG. 6 is a detailed configuration diagram of the electrical angle phase/rotation number calculation unit of FIG. 5.

FIG. 7 is a diagram illustrating a waveform of the electrical angle phase difference 241A calculated by the phase difference calculation unit 241.

FIG. 8 is a diagram illustrating a waveform of the electrical angle phase difference 242A after the filter processing.

FIG. 9 is a detailed configuration diagram of an electrical angle phase/rotation number calculation unit according to a third example of the present invention.

FIG. 10 is a schematic view of an electric vehicle according to a fourth example of the present invention.

FIG. 11 is a schematic view of an electric aircraft according to a fifth example of the present invention.

### DESCRIPTION OF EMBODIMENTS

Hereinafter, examples of the present invention will be described with reference to the drawings. Note that the same elements are denoted by the same reference numerals in principle in all the drawings. Furthermore, description of portions having the same function will be omitted. Note that the configuration described below is merely an example, and the embodiment according to the present invention is not intended to be limited to the following specific aspects.

### First Example

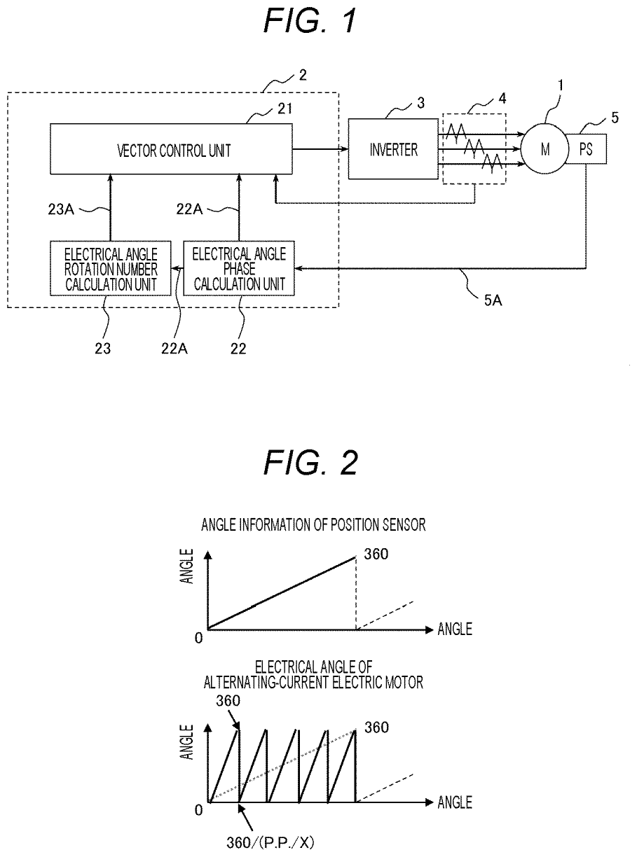

Next, a first example of the present invention will be described with reference to FIGS. 1 to 11. In the first example, an example of driving the alternating-current electric motor 1 will be described.

### Overall Configuration

FIG. 1 is a block diagram illustrating an overall configuration diagram of a driving device for an alternating-current electric motor according to a first example of the present invention.

As illustrated in FIG. 1, in a control device 2, a vector control unit 21 calculates a voltage command value based on information of a current detection circuit 4 that detects a current flowing through the alternating-current electric motor 1 and a position sensor 5 that detects a rotation position of the alternating-current electric motor 1. The inverter 3 supplies alternating-current power to the alternating-current electric motor 1 based on the voltage command value calculated by the vector control unit 21. In addition, the control device 2 includes an electrical angle phase calculation unit 22 that multiplies rotational phase information detected by the position sensor 5 to be described later by an integer multiple and converts the rotational phase information into electrical angle phase information 22A of the alternating-current electric motor 1, and an electrical angle rotation number calculation unit 23 that calculates an electrical angle rotation number of the alternating-current electric motor 1 based on the electrical angle phase information 22A calculated by the electrical angle phase calculation unit 22. A vector control unit 21 outputs a voltage command value to an inverter 3 based on the electrical angle phase information 22A calculated by electrical angle phase calculation unit 22 and the electrical angle rotation number 23A calculated by the electrical angle rotation number calculation unit 23. Note that the vector control unit 21 can be realized by using general vector control, and does not specify a control method.

### Problem When Alternating-Current Electric Motor Becomes Multipolar

As described above, as one method for reducing the size and increasing the output of the alternating-current electric motor 1, there is a design for becoming multipolar. On the other hand, when a resolver using electromagnetic induction is applied as a position sensor used in the alternating-current electric motor 1, an upper limit is generated in the number of poles that can be handled in principle. The maximum number of poles of a typical resolver is about 10 poles, and the number of poles of the multipolar alternating-current electric motor is larger than the number of poles of the resolver.

Here, a value obtained by dividing the number of poles of the alternating-current electric motor by two is referred to as a number of polar pairs P.P. The number of polar pairs is the number of pairs of N poles and S poles of the magnet. The rotation number ωr×P.P. obtained by multiplying the mechanical rotation number ωr of the alternating-current electric motor by the number of polar pairs is referred to as an electrical angle rotation number, and the vector control is calculated based on the electrical angle rotation number.

Furthermore, a ratio of how many rotations of the phase are output when the alternating-current electric motor mechanically makes one rotation with respect to the resolver which is the position sensor is referred to as an axial double angle X. For example, a case of X=2 in which a phase for two rotations appears in a case of one rotation is referred to as 2X.

As described above, since there is an upper limit on the number of poles of the resolver and there is also an upper limit on the axial double angle X of the resolver accompanying therewith, so that when the alternating-current electric motor 1 becomes multipolar, the number of polar pair P.P. becomes larger than the axial double angle X. FIG. 2 illustrates an example.

FIG. 2 is a diagram illustrating a relationship between angle information of the position sensor and an electrical angle of the alternating-current electric motor. FIG. 2 illustrates a waveform example of angle information in a case where the axial double angle of the position sensor and the number of polar pairs of the alternating-current electric motor are five times. As illustrated in FIG. 2, when the mechanical rotation angle of the alternating-current electric motor is taken on the horizontal axis and the angle information of the position sensor is taken on the vertical axis, while the angle information of the position sensor makes one rotation from 0 degrees to 360 degrees as illustrated in the upper diagram, the electrical angle of the electric motor rotates by (number of polar pair P.P./axial double angle X) as illustrated in the lower diagram. The example of FIG. 2 illustrates an example in which the (number of polar pair P.P./axial double angle X) makes five rotations.

### Configuration of First Example

In the first example, the alternating-current electric motor 1 and the resolver that is the position sensor 5 are configured such that a value obtained by dividing the number of polar pair P.P. of the alternating-current electric motor 1 by the axial double angle X of the resolver that is the position sensor 5, that is, a ratio (ratio of number of polar pair P.P. of alternating-current electric motor 1 to axial double angle X) of the number of polar pair P.P. of the alternating-current electric motor 1 with respect to the axial double angle X has an integer multiple relationship. In other words, the alternating-current electric motor 1 and the position sensor 5 are configured such that (number of polar pair P.P./axial double angle X)=N (N: integer).

As a result, the electrical angle phase information 22A of the alternating-current electric motor 1 can be calculated with a simple configuration in which the angle information 5A output from the position sensor 5 is multiplied by N (integer multiple) by the electrical angle phase calculation unit 22 to be information of 0 degrees to 360 degrees.

As an example of simple calculation, in a case where a value obtained by AD converting the position sensor angle information is taken as a fixed point, the angle information can be multiplied by N while being kept at the fixed point, so that the calculation can be performed at high speed.

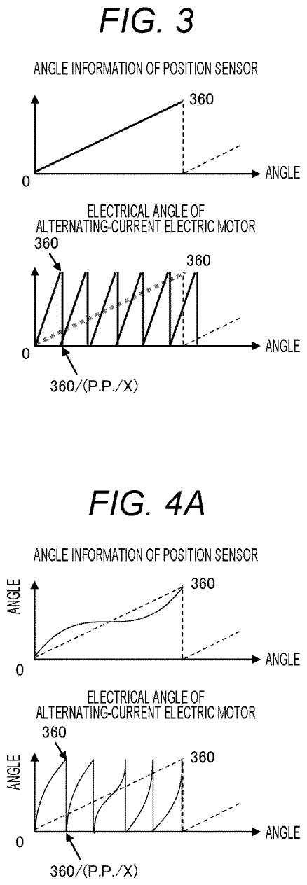

A comparative example will be described with reference to FIG. 3. FIG. 3 is a diagram illustrating a relationship between angle information of a position sensor and an electrical angle of an alternating-current electric motor according to a comparative example. FIG. 3 illustrates waveform examples of the angle information of the position sensor, the axial double angle of the position sensor, and the angle information in a case where the number of polar pairs of the alternating-current electric motor is 5.5 times.

As illustrated in FIG. 3, in the case of shapes other than when (number of polar pair P.P./axial double angle X)=5.5 times and \integer multiples, it is necessary to consider the magnification after the decimal point. For example, in a case where a value obtained by AD converting the position sensor angle information is taken in as a fixed point, it is necessary to multiply a value such as 2.5*2\hat{ }10 including a bit shift and then divide by the bit shift of 2\hat{ }10 in order to avoid a digit loss of a decimal point of 0.5 of 5.5 times. Therefore, the control device needs to perform an extra operation for the bit shift.

Therefore, in the first example, the alternating-current electric motor 1 and the position sensor 5 are configured such that (number of polar pair P.P./axial double angle X)=N (N: integer).

As illustrated in FIG. 1, the control device 2 of the first example includes an electrical angle phase calculation unit 22 that multiplies angle information 5A of the alternating-current electric motor 1 detected by the position sensor 5 by an integer multiple and converts it into electrical angle phase information 22A of the alternating-current electric motor 1, an electrical angle rotation number calculation unit 23 that calculates an electrical angle rotation number 23A of the alternating-current electric motor 1 based on the electrical angle phase information 22A of the alternating-current electric motor 1 calculated by the electrical angle phase calculation unit 22, and a vector control unit 21 that calculates a voltage command value to be output to an inverter 3 based on the electrical angle phase information 22A of the alternating-current electric motor 1 calculated by the electrical angle phase calculation unit 22 and the electrical angle rotation number 23A of the alternating-current electric motor 1 calculated by the electrical angle rotation number calculation unit 23. The electrical angle rotation number calculation unit 23 may calculate the rotation number with a general configuration such as a configuration for differentiating the phase or a proportional integral control configuration.

According to the first example, with the above configuration, it is possible to stably perform vector control on the multipolar alternating-current electric motor 1.

### Second Example

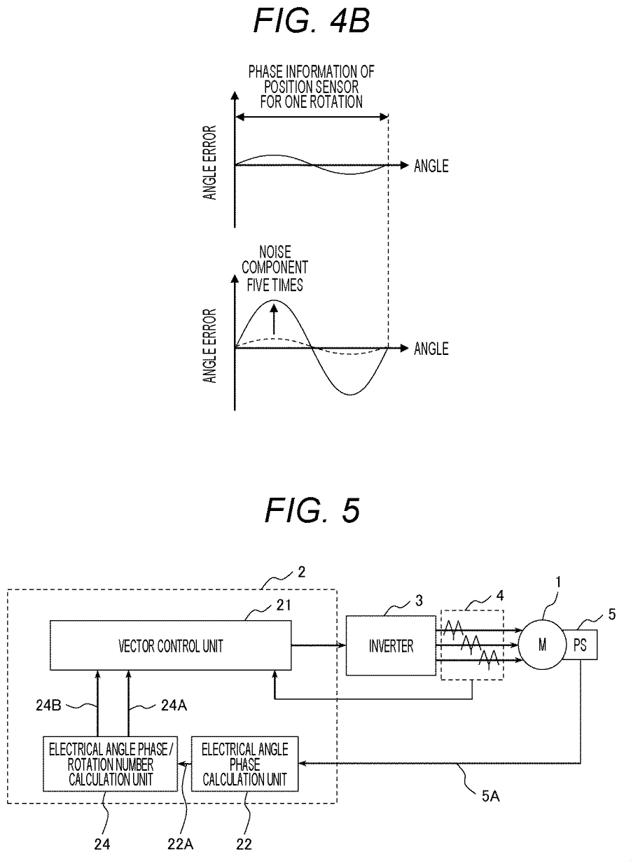

Next, a second example will be described with reference to FIGS. 4 to 8. It is known that when a resolver is used as a position sensor, noise components such as first-order and second-order noise components are generated while angle information of the resolver rotates once by 360 degrees due to a mounting error or the like.

Since the phase angle of the resolver outputs the phase angle for the axial double angle X rotation while the alternating-current electric motor makes one mechanical rotation, the frequency of the first-order noise component becomes a frequency component obtained by setting the mechanical rotation number ωr×axial double angle X times, where ωr is the mechanical rotation number of the alternating-current electric motor 1. Similarly, the N-order noise component is a frequency component of the mechanical rotation number ωr×axial double angle X times ×N times.

FIG. 4A is a diagram illustrating a relationship between angle information of a position sensor including a noise component and an electrical angle of an alternating-current electric motor. FIG. 4B is a diagram comparing the noise component for one rotation of the position sensor phase information with the noise component after the calculation by the electrical angle phase calculation unit 22. FIGS. 4A and 4B illustrate a case where the first-order noise component is generated in the position sensor angle information of the resolver in the configuration of (number of polar pair P.P./axial double angle X)=5 times.

As illustrated in the upper diagram of FIG. 4A, in the case of the first-order noise component, an angle error occurs once with respect to the angle information without noise of the dotted line while the angle information of the resolver makes one rotation. In other words, as illustrated in the upper diagram of FIG. 4B, the increase or decrease of the angle error occurs once while the angle information of the resolver makes one rotation. Accordingly, when the angle information of the resolver is set to (number of polar pair P.P./axial double angle X)=5 times by the electrical angle phase calculation unit 22, the first-order noise component described above is also superimposed on the electrical angle phase information 22A of the alternating-current electric motor 1.

Since a noise component is also generated in the electrical angle of the alternating-current electric motor 1 as illustrated in the lower diagram of FIG. 4A, when the angle information of the resolver is set to (number of polar pair P.P./axial double angle X)=5 times by the electrical angle phase calculation unit 22, the noise component becomes 5 times larger than the original noise component as illustrated in the lower diagram of FIG. 4B. When the electrical angle rotation number is calculated using the position sensor angle information including such a noise component and vector control is performed, current pulsation occurs in the alternating-current electric motor 1, and a problem that control becomes unstable occurs.

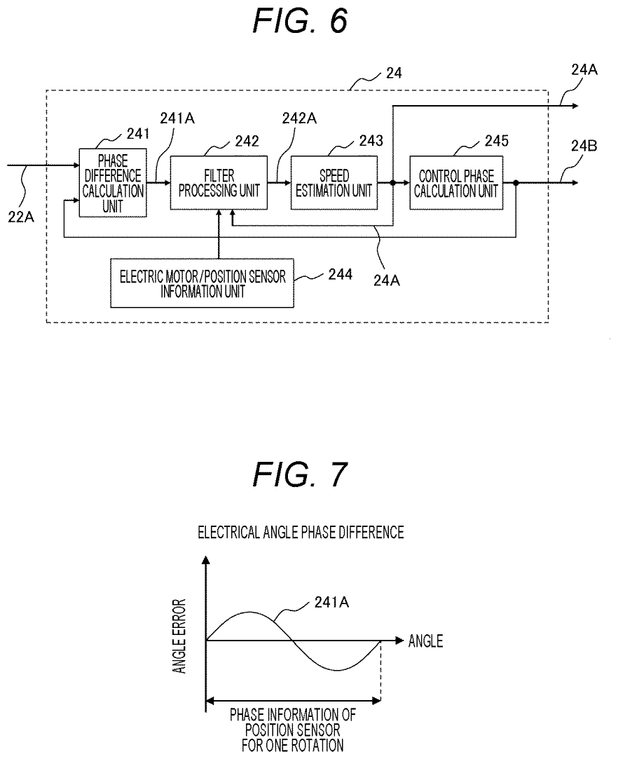

Therefore, in the second example, filter processing is performed to remove the noise component. FIG. 5 is a block diagram illustrating an overall configuration diagram of a driving device for an alternating-current electric motor according to a second example of the present invention. FIG. 6 is a detailed configuration diagram of the electrical angle phase/rotational number calculation unit of FIG. 5. Configurations common to the first example are denoted with the same reference numerals, and a detailed description thereof will be omitted.

As illustrated in FIG. 5, the control device 2 of the second example includes an electrical angle phase/rotation number calculation unit 24. The electrical angle phase/rotation number calculation unit 24 calculates the electrical angle rotation number 24A and the control phase 24B of the alternating-current electric motor 1 based on the electrical angle phase information 22A of the alternating-current electric motor 1 calculated by the electrical angle phase calculation unit 22. The electrical angle phase/rotation number calculation unit 24 has a function of calculating a control phase 24B in addition to the function of the electrical angle rotation number calculation unit 23 that calculates the electrical angle rotation number of the alternating-current electric motor 1 based on the electrical angle phase information 22A of the alternating-current electric motor 1. In other words, electrical angle phase/rotation number calculation unit 24 is an electrical angle rotation number calculation unit 23 having a function of calculating the control phase 24B.

As illustrated in FIG. 6, the electrical angle phase/rotation number calculation unit 24 includes a phase difference calculation unit 241, a filter processing unit 242, a speed estimation unit 243, an electric motor/position sensor information unit 244, and a control phase calculation unit 245. The electric motor/position sensor information unit 244 stores information on the number of polar pairs P. P. of the alternating-current electric motor 1 and the axial double angle X of the resolver.

The electrical angle phase/rotation number calculation unit 24 receives the electrical angle phase information 22A and the control phase 24B, and calculates the electrical angle phase difference 241A that is a difference between the electrical angle phase information 22A and the control phase 24B. FIG. 7 is a diagram illustrating a waveform of the electrical angle phase difference 241A calculated by the phase difference calculation unit 241. As illustrated in FIG. 7, electrical angle phase difference 241A calculated by phase difference calculation unit 241 is increased or decreased once while the angle information about the resolver that is the position sensor makes one rotation. In other words, the frequency of the noise component included in the electrical angle phase difference 241A is a frequency component of mechanical rotation number ωr×axial double angle X times, where ωr is the mechanical rotation number of the alternating-current electric motor.

Therefore, the filter processing unit 242 performs filter processing of reducing a frequency component obtained by multiplying the mechanical rotation number ωr of the alternating-current electric motor 1 by the axial double angle X times (mechanical rotation number ωr×axial double angle X times) based on the electrical angle phase difference 241A, the information of the number of polar pair P.P. of the alternating-current electric motor 1 and the axial double angle X of the resolver output from the electric motor/position sensor information unit 244, and the electrical angle rotation number 24A of the alternating-current electric motor 1.

Here, the mechanical rotation number ωr is obtained by dividing the electrical angle rotation number 24A of the alternating-current electric motor 1 by the number of polar pairs P.P. of the electric motor. Examples of the filter processing include a configuration in which the frequency component is reduced by a notch filter.

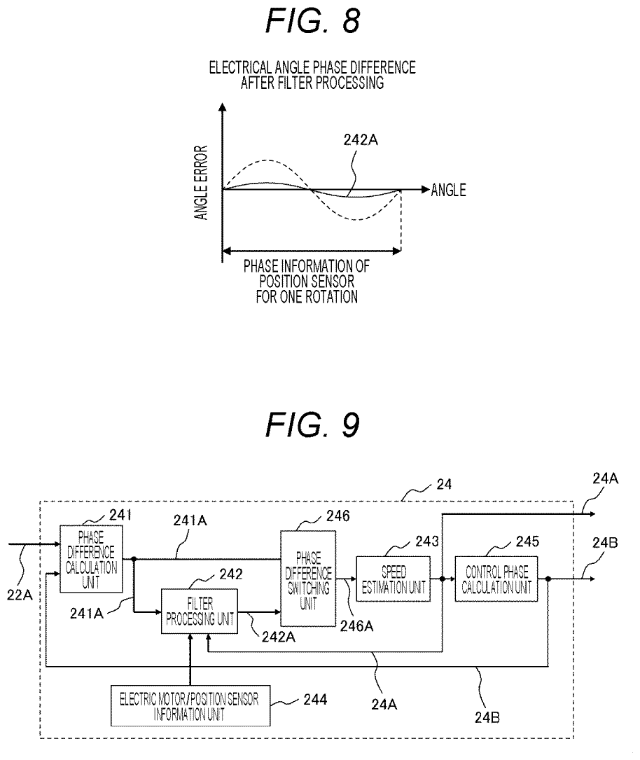

FIG. 8 is a diagram illustrating a waveform of the electrical angle phase difference 242A after the filter processing. As illustrated in FIG. 8, in the electrical angle phase difference 242A after the filter processing, the noise component included in the electrical angle phase difference 241A is suppressed and output by the filter processing unit 242.

As described above, the speed estimation unit 243 calculates the electrical angle rotation number 24A of the alternating-current electric motor 1 based on the electrical angle phase difference 242A after the filter processing in which the noise component is suppressed, and the control phase calculation unit 245 calculates the control phase 24B used by the vector control unit 21 based on the electrical angle rotation number 24A of the alternating-current electric motor 1. The speed estimation unit 243 can perform calculation by using a general configuration such as proportional/integral control calculation and the control phase calculation unit 245 can perform calculation such as integral calculation.

In the configuration described above, the case where the first-order noise component is generated in the resolver has been described, but in the case where the Nth-order noise such as the second-order noise and the third-order noise is generated in the resolver, the Nth-order noise component can be suppressed by multiplying the axial double angle X of the position sensor axial double angle information by N (integer multiple).

As described above, in the second example, the electrical angle rotation number 24A and the control phase 24B of the alternating-current electric motor 1 in which the noise component included in the angle information of the position sensor is suppressed are calculated, and based on these, the alternating-current electric motor is controlled by the vector control 21, whereby the current pulsation generated by the inclusion of the noise component can be suppressed, and the vector control can be stabilized.

### Third Example

Hereinafter, a third example will be described with reference to FIG. 9. The influence of the electrical angle phase error becomes significant even in a region where the rotation number of the alternating-current electric motor 1 is high. As illustrated in FIG. 7, in a case where the first-order noise occurs in the electrical angle phase difference with respect to one rotation of the position sensor phase information, the absolute value of the rotation number variation increases as the rotation number of the alternating-current electric motor 1 increases even with an angle error of the same proportion.

For example, it is assumed that, in the configuration of (number of polar pair P.P./axial double angle X)=5 times, the angle error of the resolver includes an error of 2%, and the influence thereof appears in the rotation number. In this case, since the noise component becomes 5 times in the electrical angle phase calculation unit 22, an error of 10% appears in the rotation number. Therefore, 1 Hz±0.1 Hz is obtained in the case of 1 Hz, but 110 Hz is obtained in the case of 100 Hz, and the absolute value cannot be ignored in the case of 100 Hz. In other words, the influence of the angle error on the absolute value of the rotation number is small in a region where the rotation number of the alternating-current electric motor 1 is low, and the influence of the angle error on the absolute value of the rotation number increases as the rotation number of the alternating-current electric motor 1 increases.

Means for solving this will be described. FIG. 9 is a detailed configuration diagram of an electrical angle phase/rotation number calculation unit according to a third example of the present invention. Configurations common to the first example and the second example are denoted by the same reference numerals, and the detailed description thereof will be omitted. The third example includes a phase difference switching unit 246 in addition to the configuration of the second example. The phase difference switching unit 246 switches whether to use the electrical angle phase difference 242A filter processed by the filter processing unit 242 or to use the electrical angle phase difference 241A output from the phase difference calculation unit 241 as it is.

The phase difference switching unit 246 selects the electrical angle phase difference 241A of the phase difference calculation unit when the rotation number of the alternating-current electric motor 1 is lower than a predetermined value, and selects the electrical angle phase difference 242A filter processed by the filter processing unit 242 when the rotation number of the alternating-current electric motor 1 is higher than the predetermined value.

According to the third example, when the rotation number of the alternating-current electric motor 1 is lower than the predetermined value, the vector control can be performed using the electrical angle phase difference excluding the influence of the filter, and the calculation load of the control device 2 can be reduced.

In addition, in order to suppress the variation at the time of switching, the phase difference switching unit 246 may be configured to provide a predetermined lower limit value and a predetermined upper limit value of the rotation number of the alternating-current electric motor 1. In this configuration, the electrical angle phase difference of the phase difference calculation unit 241 is selected when the rotation number of the alternating-current electric motor 1 is lower than the predetermined lower limit value, and the electrical angle phase difference filter processed by the filter processing unit 242 is selected when the rotation number of the alternating-current electric motor 1 is higher than the predetermined upper limit value,. Furthermore, when the rotation number of the alternating-current electric motor 1 is between a predetermined lower limit value and a predetermined upper limit value, the phase difference switching unit 246 tapers the electrical angle phase difference 241A output from the phase difference calculation unit 241 and the electrical angle phase difference 242A after the filter processing output from the filter processing unit according to the ratio between the difference between the predetermined lower limit value and the rotation number of the alternating-current electric motor 1 and the difference between the predetermined lower limit value and the predetermined upper limit value.

Specifically, the proportion d=Δωlow/ΔωHL of the difference Δωlow between the rotation number of the alternating-current electric motor 1 and the predetermined lower limit value and the difference ΔωHL from the predetermined lower limit value to the predetermined upper limit value is used to output the electrical angle phase difference output 246A of the phase difference switching unit 246 such that “electrical angle phase difference output 246A=(1−d)×electrical angle phase difference 241A+d×electrical angle phase difference 242A”. As a result, the shock at the time of switching the electrical angle phase difference by the phase difference switching unit 246 can be reduced.

### Fourth Example

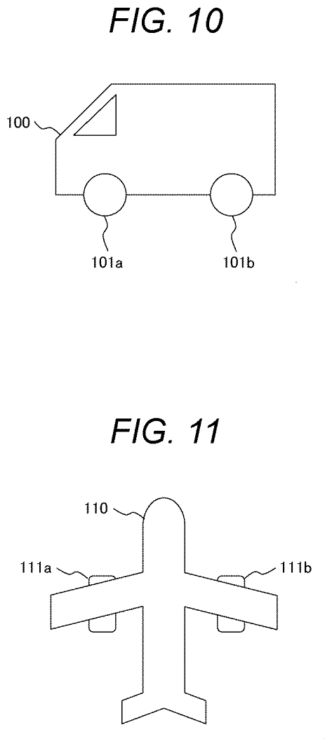

Next, a fourth example will be described with reference to FIG. 10. FIG. 10 is a schematic view of an electric vehicle according to a fourth example of the present invention.

As illustrated in FIG. 10, the electric vehicle 100 includes in-wheel motors 101a and 101b in which the alternating-current electric motor 1 is disposed on the wheel. Since the in-wheel motors 101a and 101b do not require an electric motor for driving the wheel on the vehicle body side, the vehicle interior space and the battery installation space can be expanded. As the control device 2 of the alternating-current electric motor 1, any configuration of first to third examples is used.

According to the fourth example, the vector control can be performed using the resolver with a small number of poles even for the alternating-current electric motor with multiple poles for miniaturization and high power density, so that the control configuration can be constructed at low cost without using the dedicated position sensor corresponding to multiple poles.

### Fifth Example

Next, a fifth example will be described with reference to FIG. 11. FIG. 11 is a schematic diagram of an electric aircraft according to a fifth example of the present invention.

As illustrated in FIG. 11, an electric aircraft 110 is arranged with the alternating-current electric motor 1 that drives propulsion fans 111a and 111b. As the control device 2 of the alternating-current electric motor 1, any configuration of first to third examples is used.

According to the fifth example, the use of the alternating-current electric motor having a small size and a high power density makes it possible to improve the electric cost of the jet engine and suppress CO2 emission. In addition, since vector control can be performed using a resolver with a small number of poles even for an alternating-current electric motor with multiple poles for miniaturization and high power density, a highly reliable and stable control configuration can be constructed at low cost using a resolver having high environmental resistance in a severe environment where there are many vibrations due to high altitude environment and fan operation.

Note that the present invention is not limited to the embodiments described above, and includes various modified examples. For example, the examples described above have been described in detail for the sake of easy understanding of the present invention, and are not necessarily limited to those having all the described configurations. In addition, a part of the configuration of a certain example can be replaced with a configuration of another example, and the configuration of a certain example can be added with the configuration of another example. Furthermore, for a part of the configuration of each example, other configurations can be added, deleted, and replaced.

### Reference Signs List

1 alternating-current electric motor
2 control device
3 inverter
4 current detection circuit
5 position sensor
5A angle information
21 vector control unit
22 electrical angle phase calculation unit
22A electrical angle phase information
23 electrical angle rotation number calculation unit
23A electrical angle rotation number
24 electrical angle phase/rotation number calculation unit
24A electrical angle rotation number
24B control phase
100 electric vehicle
101a, 101b in-wheel motor
110 electric aircraft
111a, 111b propulsion fan
241 phase difference calculation unit
241A electrical angle phase difference
242 filter processing unit
242A electrical angle phase difference
243 speed estimation unit
244 electric motor/phase sensor information unit
245 control phase calculation unit
246 phase difference switching unit
246A electrical angle phase difference output

1. A control device for an alternating-current electric motor that controls an alternating-current electric motor via an inverter based on angle information of a position sensor that detects an angular position of the alternating-current electric motor, wherein
the position sensor is set such that a ratio between a number of polar pairs of the alternating-current electric motor and an axial double angle X of the position sensor is an integer multiple, and
the control device includes,
an electrical angle phase calculation unit that multiplies angle information of the alternating-current electric motor detected by the position sensor by the integer multiple and converts the multiplied angle information into electrical angle phase information of the alternating-current electric motor,
an electrical angle rotation number calculation unit that calculates an electrical angle rotation number of the alternating-current electric motor based on the electrical angle phase information of the alternating-current electric motor calculated by the electrical angle phase calculation unit, and
a vector control unit that calculates a voltage command value to be output to the inverter based on the electrical angle phase information of the alternating-current electric motor calculated by the electrical angle phase calculation unit and the electrical angle rotation number of the alternating-current electric motor calculated by the electrical angle rotation number calculation unit.

2. The control device for the alternating-current electric motor according to claim 1, wherein
the electrical angle rotation number calculation unit is an electrical angle phase/rotation number calculation unit having a function of calculating a control phase of the alternating-current electric motor based on electrical angle phase information of the alternating-current electric motor calculated by the electrical angle phase calculation unit, and
the electrical angle phase/rotation number calculation unit includes,
a phase difference calculation unit that calculates an electrical angle phase difference that is a difference between the electrical angle phase information and the control phase,
a filter processing unit configured to reduce, based on the electrical angle phase difference calculated by the phase difference calculation unit, information on the number of polar pairs of the alternating-current electric motor and the axial double angle X of the position sensor, and the electrical angle rotation number of the alternating-current electric motor, a frequency component obtained by integer multiplying the mechanical rotation number of the alternating-current electric motor by an axial double angle X;
a speed estimation unit that estimates an electrical angle rotation number of the alternating-current electric motor based on the electrical angle phase difference filter processed by the filter processing unit; and
a control phase calculation unit that calculates a control phase used by the vector control unit based on the electrical angle rotation number of the alternating-current electric motor calculated by the speed estimation unit.

3. The control device for the alternating-current electric motor according to claim 2, further comprising
a phase difference switching unit that switches whether an electrical phase difference input to the speed estimation unit is an electrical angle phase difference from the phase difference calculation unit or an electrical angle phase difference filter processed by the filter processing unit according to the rotation number of the alternating-current electric motor.

4. The control device for the alternating-current electric motor according to claim 3, wherein the phase difference switching unit selects the electrical angle phase difference of the phase difference calculation unit when the rotation number of the alternating-current electric motor is lower than a predetermined value, and selects the electrical angle phase difference filter processed by the filter processing unit when the rotation number of the alternating-current electric motor is higher than the predetermined value.

5. The control device for the alternating-current electric motor according to claim 3, wherein
the phase difference switching unit includes a predetermined lower limit value of the rotation number of the alternating-current electric motor and a predetermined upper limit value set to a rotation number higher than the predetermined lower limit value,
selects an electrical angle phase difference of the phase difference calculation unit when the rotation number of the alternating-current electric motor is lower than the predetermined lower limit value, and selects an electrical angle phase difference filter processed by the filter processing unit when the rotation number of the alternating-current electric motor is higher than the predetermined upper limit value, and
when the rotation number of the alternating-current electric motor is between the predetermined lower limit value and the predetermined upper limit value, an electrical angle phase difference output from the phase difference calculation unit according to a ratio of a difference between the predetermined lower limit value and the rotation number of the alternating-current electric motor and a difference between the predetermined lower limit value and the predetermined upper limit value, and an electrical angle phase difference after filter processing output from the filter processing unit are output in a tapered manner according to the ratio.

6. An electric vehicle including a control device for an alternating-current electric motor that is disposed on a wheel in the alternating-current electric motor and controls the alternating-current electric motor, the electric vehicle comprising
a control device for alternating-current electric motor according to claim 1.

7. An electric aircraft including a control device for an alternating-current electric motor that is disposed on a propulsion fan in the alternating-current electric motor and controls the alternating-current electric motor, the electric aircraft comprising
a control device for the alternating-current electric motor according to claim 1.
